(19) United States
(12) Patent Application Publication
(10) Pub. No.: US 2023/0267339 A1
(43) Pub. Date: Aug. 24, 2023

(54) INTERPRETABLE CLUSTERING VIA MULTI-POLYTOPE MACHINES

(71) Applicant: International Business Machines Corporation, Armonk, NY (US)

(72) Inventors: Dzung Tien Phan, Pleasantville, NY (US); Connor Aram Lawless, Oakville (CA); Jayant R. Kalagnanam, Briarcliff Manor, NY (US); Lam Minh Nguyen, Ossining, NY (US); Chandrasekhara K. Reddy, Kinnelon, NJ (US)

(21) Appl. No.: 17/675,202

(22) Filed: Feb. 18, 2022

(51) Int. Cl. G06N 5/02

(52) U.S. Cl. CPC G06N 5/022

(57) ABSTRACT

In unsupervised interpretable machine learning, one or more datasets having multiple features can be received. A machine can be trained to jointly cluster and interpret resulting clusters of the dataset by at least jointly clustering the dataset into clusters and generating hyperplanes in a multi-dimensional feature space of the dataset, where the hyperplanes separate pairs of the clusters, where a hyperplane separates a pair of clusters. Jointly clustering the dataset into clusters and generating hyperplanes can repeat until convergence, where the clustering in a subsequent iteration uses the generated hyperplanes from a previous iteration to optimize performance of the clustering. The hyperplanes can be adjusted to further improve the performance of the clustering. The clusters and interpretation of the clusters can be provided, where a cluster's interpretation is provided based on hyperplanes that construct a polytope containing the cluster.

### BACKGROUND

The present application relates generally to computers and computer applications, and more particularly to machine learning and interpretable machine learning that learns jointly to cluster and provide interpretability.

Machine learning can include supervised learning and unsupervised learning. A category of unsupervised learning includes learning to cluster groups of data based on some characteristics of the data. Thus, clustering can be considered an unsupervised machine learning problem that aims to partition unlabeled data into groups. The output of a clustering algorithm is a partition of the data into groups. For example, clustering splits unlabeled data into groups that are similar, for example, outputs a set of cluster labels. In practice, clustering is often used as a tool for discovering sub-populations within a dataset such as customer segments, disease heterogeneity, and movie genres, to name a few. In these applications the group assignment itself can often be of secondary importance to the interpretation of the groups found. However, traditional clustering machine learning algorithms may simply output a set of cluster assignments and provide no explanation or interpretation for the discovered groups.

In some interpretable methodologies, explanations are added post-hoc, that is, after the clustering assignment is completed, for example, working backwards to describe features of each group to understand aspects of those groups and piece together distinguishing aspects of the groups. Interpretable methodologies that are integrated approaches aim to remove the second post-hoc processing by performing clustering in a way that jointly clusters and provides description of the groups. However, current integrated approaches in unsupervised clustering or machine learning provide rectangular descriptions of the clusters. Thus, for example, while there currently exist many optional approaches for interpretable supervised machine learning, which include both post-hoc and integrated approaches (e.g., linear regression (e.g., observing coefficients), logistic regression, decision tree, rule sets and scorecards, and sparse linear models), interpretable approaches to unsupervised machine learning or clustering are still limited.

### BRIEF SUMMARY

The summary of the disclosure is given to aid understanding of a computer system and method of interpretable clustering machine learning, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A system that can train a machine to perform unsupervised interpretable machine learning, in one aspect, can include at least one processor and a memory device coupled with the at least one processor. The at least one processor can be configured to at least receive a dataset having multiple features. The at least one processor can also be configured to train to jointly cluster and interpret resulting clusters of the dataset by at least clustering the dataset into clusters. To train to jointly cluster and interpret resulting clusters, the at least one processor can also be configured to generate hyperplanes in a multi-dimensional feature space of the dataset. The hyperplanes separate pairs of the clusters, where a hyperplane separates a pair of clusters. To train to jointly cluster and interpret resulting clusters, the at least one processor can also be configured to repeat the clustering and generating until convergence, where the clustering in a subsequent iteration uses the generated hyperplanes from a previous iteration to optimize performance of the clustering. To train to jointly cluster and interpret resulting clusters, the at least one processor can also be configured to adjust the hyperplanes to further improve the performance of the clustering. The at least one processor can also be configured to provide the clusters and interpretation of the clusters, where a cluster's interpretation is provided based on hyperplanes that construct a polytope containing the cluster.

A computer-implemented method of training a machine to perform unsupervised interpretable machine learning, in an aspect, can include receiving a dataset having multiple features. The computer-implemented method can also include clustering the dataset into clusters. The computer-implemented method can also include generating hyperplanes in a multi-dimensional feature space of the dataset. The hyperplanes separate pairs of the clusters, for example, a hyperplane separates a pair of clusters. The computer-implemented method can also include repeating the clustering and generating until convergence, where the clustering in a subsequent iteration uses the generated hyperplanes from a previous iteration to optimize performance of the clustering. The computer-implemented method can also include adjusting the hyperplanes to further improve the performance of the clustering. The computer-implemented method can also include providing the clusters and interpretation of the clusters, where a cluster's interpretation is provided based on hyperplanes that construct a polytope containing the cluster, where the machine is trained to jointly cluster and interpret resulting clusters of the dataset.

Technical benefits and/or advantages of using a machine learning technique that can provide interpretable clustering as disclosed herein can include providing flexibility in interpretability of the clusters being generated, which for example can be controlled via configurable parameters. Such flexibility can, in turn also provide savings in processing power (e.g., central processing unit (CPU) and/or another processor such as graphics processing unit (GPU) and/or others) and network resource usage, for example, as fewer numbers of trial runs need be performed to reach a desired degree of interpretability. Yet another technical benefit can include providing the ability to control the complexity of interpretability, which in turn can control the usage and savings of processing power such a processor usage.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a polytope in an embodiment.

FIG. 2 shows an example of a polytope cluster explanation under the three different constraints in an embodiment.

FIG. 3 is a flow diagram illustrating a method of unsupervised machine learning or clustering with interpretability in an embodiment.

FIG. 4 shows possible options in coordinate descent in an embodiment.

FIG. 5 is another diagram illustrating a framework for interpretable unsupervised machine learning or clustering with multi-polytope machines in an embodiment.

FIG. 6 is a diagram showing components of a system in one embodiment that can perform interpretable clustering with multiple polytope machines.

FIG. 7 illustrates a schematic of an example computer or processing system that may implement a system in one embodiment.

FIG. 8 illustrates a cloud computing environment in one embodiment.

FIG. 9 illustrates a set of functional abstraction layers provided by cloud computing environment in one embodiment of the present disclosure.

### DETAILED DESCRIPTION

While machine learning can output cluster labels, for many domains, there can be a need to characterize data clusters or understand their distinctive features. For example, clustering is often used in customer segmentation to understand the different types of customers within an organization. As another example, in medical imaging, it would help to not only correctly classify whether an image scan had a certain disease, but also to characterize the heterogeneity in the disease. Thus, identifying clusters and interpretations of those clusters, for example, the defining characteristics of each cluster, would be beneficial. Interpretable clustering aims to develop clusters with interpretability in the process, eliciting not only a partition but a description of the clusters, for example, jointly cluster points and provide an explanation of the groups themselves.

Systems, methods and techniques can be provided in one or more embodiments for interpretable clustering via multi-polytope machines. The approach disclosed herein, for example, can bridge the gap between supervised learning approaches and unsupervised interpretable clustering approaches and provide practitioner or machine learning developers with more flexibility in how they choose to interpret and describe clusters, for example, provide flexibility to unsupervised machine learning interpretability. For instance, in addition to having rectangular boxes to describe each cluster, more flexible function classes or more general polytopes can be provided. In addition, constraints on the separating hyperplanes can be provided that cover other supervised machine learning classes. For instance, the approach disclosed here may ensure that these lines or hyperplanes are sparse and have integer coefficients such that the resulting description can resemble a scorecard or the like. In an embodiment, the clustering approach incorporates the interpretation task in the generation of the clusters. For example, multi-polytope clustering (MPC) jointly clusters points and describes each cluster with a polytope. Interpretable clustering disclosed herein can provide cluster explanations by constructing polytopes around each cluster.

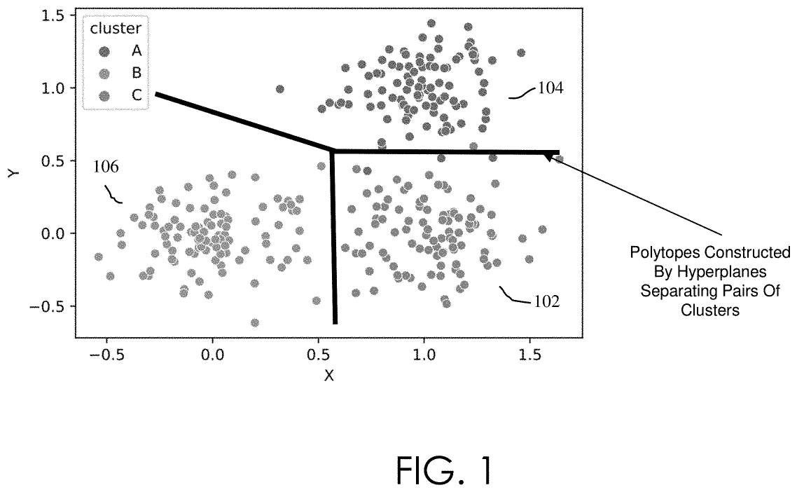

For example, a system and/or method can describe each cluster by constructing a polytope around it. A polytope can be considered the intersection of half-spaces. FIG. 1 shows an example of a polytope in a 2-dimensional space in an embodiment. Consider that a data set includes data points shown. Examples of the data set can include, but not be limited to, video or image data, for example, pixel data, audio data, for example, acoustic signals, text data. For example, the data points are clustered around areas 102, 104 and 106. In constructing a polytope, for instance, a line (also referred to as a hyperplane for a multi-dimensional space for datasets with multiple attributes) is drawn in space, all the space below the line is considered the one half-space. Multiple lines can be drawn. A way to draw a line is to draw the line between every pair of clusters. For instance, to describe the cluster at 102, a line can be drawn between the data points of cluster 102 and data points that cluster at 104. All of the space below this line is considered the one half-space. Then another line can be drawn between the data points that cluster at 106 and the data points that cluster at 102. All the space to the right of this line is considered the second half-space. The intersection of the two half-spaces becomes the explanation or interpretation.

In an embodiment, interpretable clustering jointly clusters points and constructs polytopes surrounding each cluster using a mixed integer optimization non-linear programming (MINLP) formulation. In an embodiment, an MINLP framework can include as a component a representation aware k-means clustering formulation that forms clusters with interpretability integrated into the objective. A formulation to find separating hyperplanes with sparse integer coefficients for interpretability can be provided. In an embodiment, approximating the solution of the MINLP formulation can include a two-stage optimization procedure that initializes clusters via alternating minimization and then optimizes the Silhouette coefficient via coordinate descent. In an aspect, numerical experiments on both synthetic and real-world datasets show that the approach disclosed herein can outperform state of the art interpretable and uninterpretable clustering algorithms.

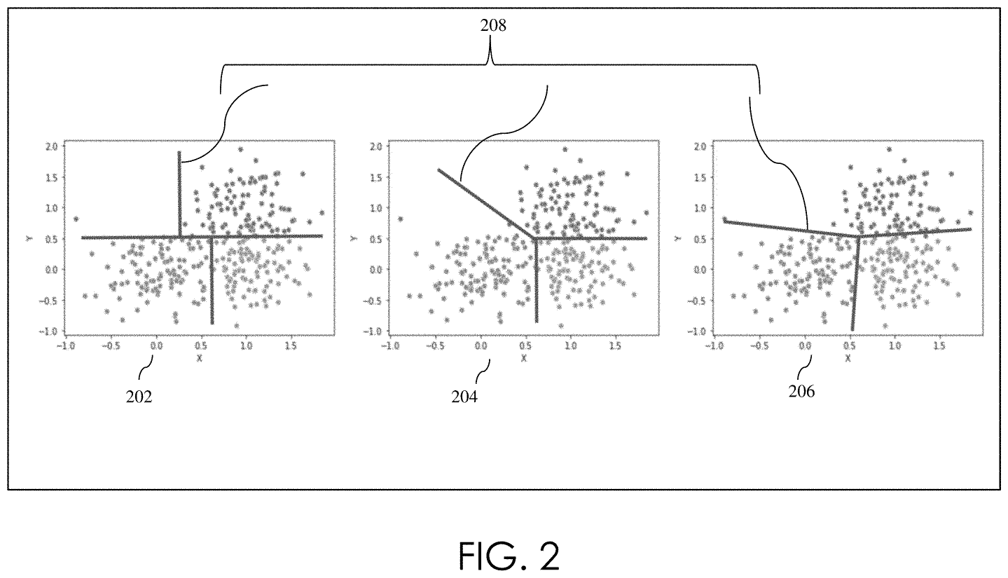

In an embodiment, the system and/or method can allow for constraints on the hyperplanes that construct each polytope allowing for a wider range of cluster explanations including axis parallel partitions (e.g., similar to decision trees), partitions defined by sparse integer hyperplanes (e.g., similar to sparse/integer models), and general linear models (e.g., similar to Support Vector Machines (SVMs)). FIG. 2 shows an example of a polytope cluster explanation under the three different constraints in an embodiment. Polytopes can be constructed by hyperplanes 208 separating pairs of clusters. Shown at 202, polytopes are composed of axis-parallel hyperplanes giving rise to rectangular cluster explanations. In an embodiment, each hyperplane corresponds to a single clause in the resulting rule. Shown at 204, polytopes are composed with integral hyperplanes allowing only diagonal or axis parallel lines. Shown at 206, polytopes are composed with general hyperplanes. Interpretable clustering disclosed herein can provide for more flexibility to explain clusters inline with the requirements of an application that uses clustering.

Compared to existing cluster explanation approaches, the interpretable clustering disclosed herein in one or more embodiments can look at a more general function class to explain clusters, can have more expressive power than decision-tree or rectangular approaches as polytopes with axis-parallel hyperplanes can be mapped to a decision tree, and can also provide more flexibility in clustering, allowing for trade-offs between the relative importance of interpretability and cluster quality.

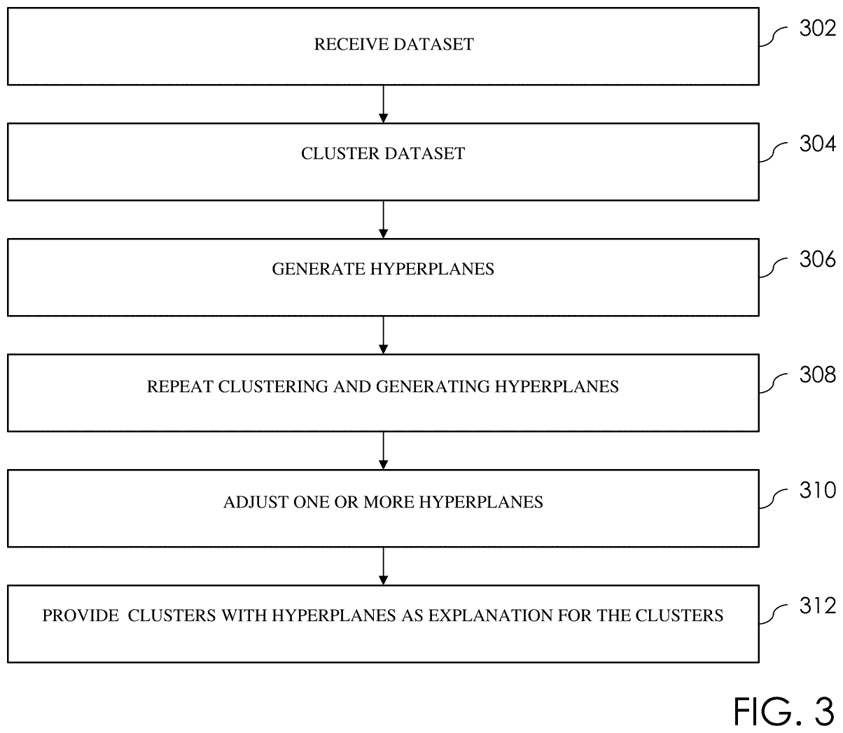

FIG. 3 is a flow diagram illustrating a method of unsupervised machine learning or clustering with interpretability in an embodiment. The method can train a machine to perform unsupervised interpretable machine learning. The method can be performed by or run on one or more computer processors including one or more hardware processors, or coupled with one or more hardware processors. One or more hardware processors, for example, may include components such as programmable logic devices, microcontrollers, memory devices, and/or other hardware components, which may be configured to perform respective tasks described in the present disclosure. Coupled memory devices may be configured to selectively store instructions executable by one or more hardware processors.

A processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium.

At 302, a dataset (or one or more datasets) having multiple features can be received. For example, in a dataset related to a zoo, different animals in the zoo can have different characteristics or features. In medical imaging data, different diseases may manifest different characteristics or features. In a dataset related to tourism or travel, different locations can have different characteristics or features, different travelers can have different preferences.

As described in detail herein, in an embodiment, the system and/or method may explain clusters via polytopes with a Mixed Integer Nonlinear Program (MINLP) formulation. In an embodiment, the system and/or method may use a semi-supervised representation aware k-means method for clustering that incorporates a cost of mis-representation. A formulation finds separating hyperplanes with sparse integer coefficients. A two-stage optimization procedure can be leveraged that initializes clusters via alternating minimization and then optimizes Silhouette or Dunn index metrics via coordinate descent.

At 304, the dataset can be clustered. At 306, hyperplanes in a multi-dimensional feature space of the dataset can be generated. The hyperplanes separate pairs of the clusters, e.g., a hyperplane separates a pair of clusters. At 308, the clustering and generating can be repeated until convergence, where the clustering in a subsequent iteration uses the generated hyperplanes from a previous iteration to optimize performance of the clustering. In an embodiment, the clustering and the generating of the hyperplanes can be performed as a single mixed integer non-linear programming that solves alternating minimization between the clustering and the hyperplane generating.

In an embodiment, an MPC formulation framework assigns labels and constructs hyperplanes between pairs of clusters. In an embodiment, the framework minimizes a combination of cluster error and representation error. In the formulation, the system and/or method can perform a trade-off between clustering and interpretability, for example, a trade-off between the quality of the clustering that is done and the quality of how well the polytopes are capturing each group. At a high-level, the formulation in an embodiment can be:

$$\begin{matrix} & Cluster Error & Representation Error & \\ {min}_{z , {c}_{k} , {u}_{k}} & f ( x , z ) & + λ g ( x , z , w , b ) & \begin{matrix}Trade - off Clustering \\ and Interpretability\end{matrix} \\ such that ( s . t . ) & & {\sum }_{k = 1}^{K} {z}_{tk} = 1 ∀ t ∈ 𝒟 & Assign Clusters \\ & & {u}_{k} lb \leq {\sum }_{t ∈ 𝒟} {z}_{tk} \leq {u}_{k} ub & \end{matrix}$$

$$\begin{matrix}{( {w}^{ij} )}^{T} {x}^{t} + {b}^{ij} \geq - {( {ξ}^{ij} )}_{t} , ∀ {x}^{t} ∈ {C}_{i} , i = 1 , … , K - 1 & Seperate Clusters \\ {( {w}^{ij} )}^{T} {x}^{t} + {b}^{ij} \leq - {( {ξ}^{ij} )}_{t} , ∀ {x}^{t} ∈ {C}_{j} , j = 1 , … , K & \\ {u}_{k} , {z}_{k} ∈ \{ 0 , 1 \} & \end{matrix}$$

The decision variables in the formulation are zₜₖ that track whether or not to assign data point x^{t} to cluster Cₖ, where there are up to K clusters. Also provided in an embodiment are cardinality constraints on the cluster size, a lower bound (lb) for the size of a cluster and an upper bound (ub) on the size of a cluster. The variables uₖ represent the binary variable indicating whether cluster Cₖ is used. There are also w^{ij} and b^{ij}, which represent hyperplanes, where there is one hyperplane for every pair of clusters. For every pair of clusters, Cᵢ, Cⱼ, the constraints would track whether a data point is on the correct side.

Clustering in an aspect can aim to obtain compact clusters that are far apart. For example, “good” clusters have low intra-cluster distance (distance between points within the same cluster) and high inter-cluster distance (distance between points in different clusters). Different methods can measure these distances differently. In an embodiment, Silhouette Coefficient and/or Dunn Index can provide metrics or a measure of whether clusters are considered “good”.

For example, in silhouette coefficient, to compute an intra-cluster distance, take a single data point i and compute an average distance from it to every other point in the cluster, e.g., a(i) term in the following represents this intra-cluster distance for i:

$$a ( i ) = \frac{1}{\vert {C}_{i} \vert - 1} {Σ}_{j ∈ {C}_{i} : i \neq j} d ( i , j ) .$$

The b(i) term in,

$$b ( i ) = {min}_{k \neq i} \frac{1}{{C}_{k}} {Σ}_{j ∈ {C}_{k}} d ( i , j ) ,$$

represents the inter-cluster distance measure, where an average distance is computed between the data point i and every point in the second closest cluster. The silhouette coefficient s(i) for the data point i in,

$$s ( i ) = \frac{b ( i ) - a ( i )}{max ( b ( i ) , a ( i ) )} ,$$

is the difference between the inter-cluster and intra-cluster distance. The max (b(i), a(i)) term can normalize the silhouette coefficient, so that the silhouette coefficient is bound to −1 (representing the absolute worst-case scenario) and +1 (representing the best).

In an embodiment, the silhouette coefficient can be formulated within the MPC framework, for example, as follows. The constraints capture the constraints described above. The term sᵢ represents a silhouette score for each of the data points i, which can be averaged over the dataset. To maximize a silhouette score, and since the MPC is a minimization problem, a negative sign is added. Incorporating silhouette coefficient directly into the formulation can introduce some non-linearity. The decision variable mᵢ in the denominator which normalizes the silhouette score between (−1, +1). In general solving MINLPs exactly for practical dataset sizes can be difficult. In an embodiment, an optimization framework is presented which uses a heuristic approach. For completeness, a full MINLP formulation is provided with silhouette coefficient.

$$\begin{matrix} & Silhouette Score & Representation Error & \\ {min}_{z , {c}_{k} , {u}_{k}} & - \frac{1}{n} {\sum }_{t ∈ D} {s}_{i} & + λ g ( x , z , w , b ) & \begin{matrix}Trade - off Silhouette \\ and Interpretability\end{matrix} \\ s . t . & Original Constraints & & \\ & {s}_{i} = \frac{{q}_{i} - {r}_{i}}{{m}_{i}} , & {q}_{i} \geq {Σ}_{k} {γ}_{ik} {c}_{ik} & \\ & {c}_{ik} = \frac{1}{{k}_{t}} {Σ}_{j ∈ D} {d}_{ij} {z}_{jk} , ∀ i , k , & {Σ}_{k} {γ}_{ik} = 1 & \begin{matrix}Track Silhouette \\ Score\end{matrix} \\ & {r}_{i} = {Σ}_{k} {c}_{it} {z}_{it} , & {γ}_{ik} \leq 1 - {z}_{it} & \end{matrix}$$

$${m}_{i} \geq {r}_{i} , {q}_{i} \\ {u}_{k} , {z}_{k} , {γ}_{ik} ∈ \{ 0 , 1 \}$$

Adding in Silhouette score to the framework transforms the problem to a Mixed Integer Nonlinear Program (MINLP), where the framework can provide a trade-off between silhouette and interpretability.

Next, the representation error of the MPC formulation provided above can be considered. In an embodiment, the representation error can be incorporated as a separating hyperplane problem. In the absence of interpretability constraints, the framework may use a Support Vector Machine (SVM) formulation. A Support Vector Machine (SVM) algorithm allows drawing a line (hyperplane) between two groups of points. One aim can be to have a line with maximum margin so that a safety band around the line can be present such that points do not fall between lines. However, using a standard SVM algorithm may not provide a guarantee on interpretability. For example, SVM algorithms can output hyperplanes that are dense that have many non-zero coefficients, can have decimals weights w^{ij}, which can be difficult to decipher intuitively or use in interpreting or explaining clusters.

Hence, to draw or generate hyperplanes, in an embodiment, a new formulation referred to as interpretable separating hyperplanes is introduced. In an embodiment, the constraints are provided to track hyperplanes. Interpretable separating hyperplane is further described in detail below. Referring to the Eq. (1)-(12), the terms w^{ij} represent coefficients of the hyperplane, b^{ij} represent the intercepts of those hyperplanes, ξₜ^{ij} represent how far the error is or how far on the wrong side of the boundary line a data point x^{t} is. Consider for simplicity of explaining the problem that there are two clusters, cluster Cᵢ, and cluster Cⱼ, and a line is being drawn between those clusters where the clusters are fixed. For providing interpretability, in embodiment, a constraint can be set that can require that all of the coefficients to be integers, and do not allow decimal values. Another constraint sets an upper bound on the maximum integer size, represented by the term ‘M’. For instance, an upper bound can be set such that the integer coefficients can be no larger than 10. Setting the maximum allowable coefficient integer size provides several benefits. For example, it allows for enumerating all possible hyperplanes, so that exhaustive local search can be performed. As another example, the maximum coefficient integer size can be considered as defining a grid of potential hyperplanes that are considered. Any general hyperplane can be normalized have to all of its coefficients to be between −1 and +1, and adding the M constraints allows the algorithm to only observe coefficients on grids between −1 and +1, in increments of 1 over M. The higher M is the finer or the larger the set of hyperplanes that are considered. For example, constraints shown below in Eq. (4)-Eq. (6) can operate to remove trivial solutions, and constraints shown below in Eq. (7)-Eq. (9) can maintain sparsity conditions.

Another way to boost or enhance the interpretability in the framework, is to set or provide a limit on the number of non-zero coefficients for the weights w^{ij} of hyperplanes. The term β provides allowable number of non-zero coefficients. The less non-zero coefficients there are, the better, since there would be less computation to perform, and the clusters would be more interpretable. Other constraints can ensure that the solution to the problem excludes, or does not output, trivial hyperplanes that are all zeros. Thus, in an embodiment, interpretable separating hyperplane minimizes separation errors, removes any trivial solutions and maintains sparsity conditions.

In an embodiment, hyperplanes can be generated based on configurable parameters that control sparsity of the hyperplanes for interpretability. The terms ‘M’ and β provide controls that allow users to specify the level of interpretability one would like to have. β represents the sparsity of a hyperplane (the number of non-zero coefficients that are allowed in it) and ‘M’ is the maximum coefficient size. Sparsity of a hyperplane defines how many features in a dataset are used in a hyperplane, where hyperplanes are drawn in the feature space. Changing ‘M’ and maximum integer coefficient parameters β allows for control over ease of interpretability. For example, referring to FIG. 2, at 202, maximum integer coefficient parameters β is set to 1 and ‘M’ set to 1, resulting in that every hyperplane is axis-parallel, e.g., parallel to either y-axis or x-axis, and that it will have an individual threshold. In this example, the resulting description may look similar to the description from the decision trees, for example, rectangular rules. Referring to 204 in FIG. 2, relaxing the terms more and allowing the algorithm to operate with two non-zero coefficient (set maximum integer coefficient parameters β to 2, ‘M’ still set to 1) can produce diagonal lines, which is more flexible than the state of the art. For example, at 204, there can be two non-zero coefficients and they can have value that is at most 1. Referring to 206 in FIG. 2, setting ‘M’ to 100 and β to 2 can provide for additional general lines, which do not have to be perfect diagonals but can be curves.

Using the silhouette score and the interpretable separating hyperplane problem, a joint problem formulation can be presented, referred to as MPC formulation. Example MPC joint formulation jointly minimizes the silhouette score (shown below at Eq. (25)) and the representation error (shown below at Eq. (26)) with the constraints discussed above for cluster points (e.g., Eq. (14)-Eq. (24)) and separate clusters (e.g., Eq. (4)-Eq. (12)). For instance, there can be all of the constraints discussed above, a silhouette score objective term, and a representation error term which can be the sum of errors from each individual hyperplane. For example, for each hyperplane, the algorithm can observe ξₜ^{ij} which represents how far the error is or on the wrong side of the boundary line, and sum up the errors.

The trade-off between how well the polytopes capture the data and how well the clustering problem is done, can be controlled by the parameter λ. The parameter λ can be a soft parameter. For example, this parameter λ may be set high for output that reflects high quality representation or interpretation. In an embodiment, this parameter can provide for the flexibility of choosing (or trading-off) between quality clustering and quality interpretability.

In an embodiment, to find a relatively good local solution, a heuristic approach can be implemented. In an embodiment, to find a solution to the MPC formulation, the system and/or method may first generate an initial clustering and hyperplane separation, then perform local search to boost performance. The procedure can be broken down into two stages. In the first stage of an optimization approach, the system and/or method may try to find an initial set of clusters that the system and/or method can explain well enough, and then once the initial set of clusters is obtained, the system and/or method may perform a local search, e.g., observe every boundary of explanations and try to improve them until a criterion is met such as convergence, or reach a threshold, e.g., try to obtain the best possible performance.

For the initialization procedure, in an embodiment, to find the initial clustering and description, an alternating minimization can be used. For example, the system and/or method may alternate between solving the clustering problem and then generating hyperplanes, e.g., drawing a plurality of lines. For example, the system and/or method may start with k-means algorithms to obtain an initial set of clusters, and then for every pair of clusters, the system and/or method may draw a line, fix those lines, and obtain a plurality of error terms, return and repeat solving the clustering terms in consideration with the parameters or error terms obtained in drawing the lines or generating the hyperplanes.

Even with fixed hyperplanes, solving the silhouette clustering problem can be difficult due to some non-linearity in the silhouette score. During the alternating minimization procedure, the system and/or method in an embodiment may use a K-means objective as a proxy for the silhouette score. In an embodiment, replacing the silhouette term with a K-means objective can lead to tractable integer programming (IP) framework. A K-means objective here can be to try to minimize the distance between every data point and a cluster center of a cluster. Each cluster, for example, has an associated center, e.g., a centroid or mean of the cluster. Eq. (31) below shows that the k-means objective term, Σₖ₌₁^{K}μₓ_{^{t}}_{∈D}zₜₖ∥x^{t}−cₖ∥², can replace the silhouette term, −1/nΣ_{t∈D}sₜ in the MPC formulation. For instance, clustering can be implemented using a representation aware k-means clustering that clusters with awareness of representation error using a clustering metric. The output of the MPC algorithm (e.g., the alternating minimization) is a set of clusters with a set of corresponding descriptions.

At 310, the hyperplanes can be adjusted to further improve the performance of the clustering. In an embodiment, the adjusting of the hyperplanes is performed based on a selected clustering metric, e.g., Silhouette index, Dunn index, or the like. For example, in the second stage of the optimization procedure, the system and/or method may perform a local search to boost the performance. Performance can be measured based on silhouette coefficient or another metric. For instance, once an initial clustering and description are obtained, the system and/or method can perform coordinate descent to improve the performance. For example, edges can be adjusted by clustering membership determined by new polytopes (which may create new clusters); clusters can be split by adding new hyperplane within cluster to subdivide into new clusters; and/or clusters can be merged by combining two clusters, e.g., between polytopes that are compatible.

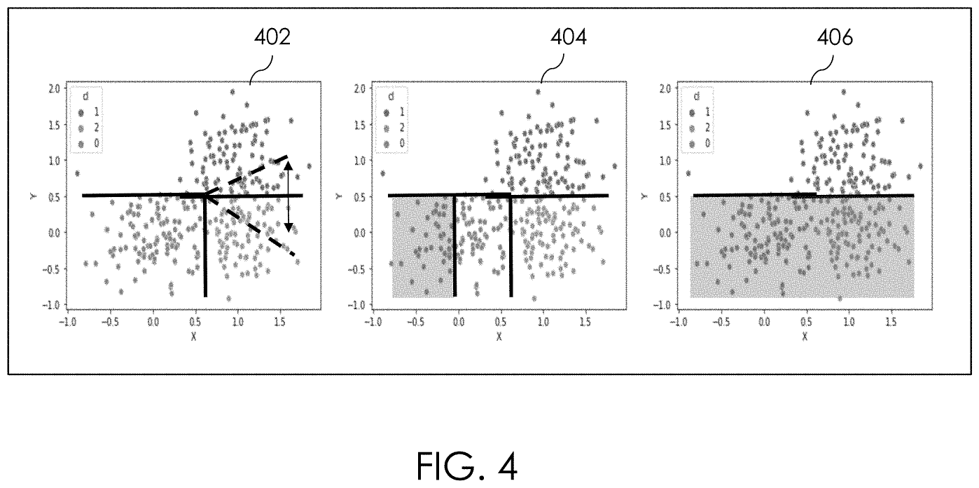

For instance, in an embodiment, every line or hyperplane that is obtained can be examined for possible adjustments. FIG. 4 shows possible options in coordinate descent in an embodiment. At 402, adjusting the edges may be considered, for example, moving the lines up or down, and computing the clustering performance based on the moved lines. For instance, moving a line or hyperplane also adjusts the cluster assignment accordingly, where some of the data points previously outside the boundaries of the lines may now be inside the boundaries due to the adjustment of the lines, or vise verse. Similarly, at 404, potential changes can include splitting clusters, e.g., drawing a line within a cluster space, and computing whether such breaking of the cluster would boost performance. At 406, yet another potential change can be merging clusters, e.g., removing a line, and determining whether there is a boost in performance (e.g., by computing the performance using the merged clusters).

In an aspect, a coordinate descent approach allows for the final clustering to be less sensitive to the specification of the original number of clusters. For example, the coordinate descent approach can be far less susceptible to the initial choice of clusters that are obtained. For example, given a hyperparameter representing a maximum number of clusters K for machine learning to learn to cluster a dataset into, performing the coordinate descent allows for finding optimal number of clusters, which can be different from the initially provided hyperparameter.

Referring to FIG. 3, at 312, the clusters and interpretation or explanation of the clusters can be provided, where a cluster's interpretation or explanation is provided based on hyperplanes that construct a polytope containing the cluster. In this way, for example, a machine can be trained to jointly cluster and interpret resulting clusters of the dataset.

In an embodiment, the lines or hyperplanes can be drawn or generated in a multi-dimensional feature space, for example, where a dataset has multiple features. Thus, hyperplanes can explain or provide a description of the clusters that are in the polytopes constructed by the hyperplanes. For example, a set of hyperplanes that define a cluster can provide description or explanation for that cluster. For example, where the number of non-zero coefficients and the maximum coefficient value is set to 1, every hyperplane can be a single condition, for example, in an example dataset relating to a zoo (referred herein as Zoo dataset) consisting of 101 animals available from a public archive, a hyperplane can correspond to “has hair”. Another hyperplane can correspond to “has milk”. Yet another hyperplane can correspond to “legs >0”. So for example, a cluster within a polytope constructed by those hyperplanes can be described as “(has hair) and (has milk) and (legs >0)” in this example dataset.

Generally, the number of hyperplanes that the algorithm generates can be a function of the number of clusters generated. There can be one hyperplane for every pair of clusters, K clusters, each cluster explanation would have K−1 hyperplanes. Hyperplanes can overlap, and overlapping hyperplanes can be removed from the description. The framework can find high-quality clusters with simple explanation for interpretability.

The following further describes the above described interpretable clustering via multi-polytope machines in more detail in an embodiment.

In a clustering setting, one is given a set of unlabelled data points D={x^{t}∈ [symbol] ^{D}}ₜ₌₁^{N} and asked to partition them into a set of K clusters C₁, . . . , C_{K}, where Cᵢ is the set of points belonging to cluster i. In an aspect, the data can have real-valued features and have an associated metric for defining pairwise distance between points. This is not a restrictive assumption as categorical data can be converted to real valued features, for example, via a standard one-hot encoding scheme. In the interpretable clustering setting, the clustering is also to provide an explanation of each cluster. In an embodiment, a system and/or method disclosed herein can explain each cluster by constructing a polytope around it. To construct such a polytope, the system and/or method can find a separating hyperplane for each pair of clusters. The intersection of the half-spaces generated by the set of hyperplanes involving each cluster then can define the polytope. In an embodiment, a mixed integer optimization formulation is disclosed for jointly finding clusters and defining polytopes. For explanation purposes, the description considers the interpretation and clustering problems separately before joining them in a unified framework.

Interpretable Separating Hyperplanes

Consider the setting where there is a fixed set of cluster assignments and one is to construct a hyperplane to separate a pair of clusters Cᵢ and Cⱼ. To construct a polytope to describe cluster Cᵢ the system and/or method may construct such hyperplane between Cᵢ and every other cluster. In an embodiment, a formulation that constructs a separating hyperplane with small integer coefficients and a limit on the number of non-zero coefficients can be provided.

Let w^{ij} and b^{ij} the slope and intercept of the separating hyperplane between clusters i and j. Furthermore let w_{d,+}^{ij} and w_{d,-}^{ij} represent non-negative components of element d in w—namely w_{d}^{ij}=w_{d,+}^{ij}−w_{d,-}^{ij}. A system and/or method in an embodiment also introduce a constant M that represents the maximum allowable integer coefficient value. To add constraints on the sparsity of the hyperplane, the system and/or method can introduce binary variables y_{d,+}^{ij} and y_{d,-}^{ij} that track whether feature d is included in the hyperplane. In an embodiment, the system and/or method put a hard constraint of β on the number of non-zero coefficients in the final hyperplane. ξₜ^{ij} tracks the mis-classification of data point t—specifically its distance from the correct side of the hyperplane to be classified correctly. Also, ϵ is a fixed constant for the minimum non-zero separation distance with respect to any feasible hyperplane (i.e., the smallest non-zero distance between two points with respect to feasible hyperplane). With this notation, the formulation for constructing an interpretable separating hyperplane in an embodiment can be as follows:

$$\begin{matrix}{min}_{w , b ,} {Σ}_{t ∈ {C}_{i} ⋃ {C}_{j}} {( {ξ}^{ij} )}_{t} & ( 1 ) \\ subject to {( {w}^{ij} )}^{T} {x}^{t} + {b}^{ij} \geq - {( {ξ}^{ij} )}_{t} , ∀ {x}^{t} ∈ {C}_{i} & ( 2 ) \\ {( {w}^{ij} )}^{T} {x}^{t} + {b}^{ij} + ϵ \leq {( {ξ}^{ij} )}_{t} , ∀ {x}^{t} ∈ {C}_{j} & ( 3 ) \\ {w}_{d , +}^{ij} - {w}_{d , -}^{ij} = {w}_{d}^{ij} ∀ d ∈ [ D ] & ( 4 ) \\ {Σ}_{d ∈ [ D ]} {w}_{d , +}^{ij} + {w}_{d , -}^{ij} \geq 1 & ( 5 ) \\ {y}_{d , +}^{ij} + {y}_{d , -}^{ij} \leq 1 , ∀ d ∈ [ D ] & ( 6 ) \\ {Σ}_{d ∈ [ D ]} {y}_{d , +}^{ij} + {y}_{d , -}^{ij} \leq β & ( 7 ) \\ 0 \leq {w}_{d , +}^{ij} \leq {My}_{d , +}^{ij} , ∀ d ∈ [ D ] & ( 8 ) \\ 0 \leq {w}_{d , -}^{ij} \leq {My}_{d , -}^{ij} , ∀ d ∈ [ D ] & ( 9 ) \\ {w}^{ij} ∈ {Z}^{d} , {w}_{+}^{ij} , {w}_{-}^{ij} ∈ {Z}_{\geq 0}^{d} & ( 10 ) \\ {( {ξ}^{ij} )}_{t} \geq 0 & ( 11 ) \\ {y}_{d}^{ij} ∈ \{ 0 , 1 \} . & ( 12 )\end{matrix}$$

The objective (1) is to minimize the classification error of the separating hyperplane. Constraints (2) and (3) track whether the system and/or method is classifying data point x^{t} correctly. The system and/or method can add ϵ to constraint (3) to ensure that the separating hyperplane is only inclusive of cluster Cᵢ. In other words, a data point in cluster Cⱼ is only classified correctly if it lies strictly below the hyperplane. Constraints (5) and (6) ensure that the trivial hyperplane (all zero) is excluded by ensuring that the l₁ norm of the hyperplane is above 1 (the smallest possible l₁ norm of an integer hyperplane) and that only at most one of w_{d,+}^{ij} and w_{d,-}^{ij} are non-zero. Constraint (7) bounds the number of non-zero coefficients. Constraints (8) and (9) constrain the maximum integer values of the coefficients. One interpretation of the constant M is that it controls the search space of possible hyperplanes. Start by noting that any general hyperplane can be normalized to have coefficients between −1 and 1 by dividing by the largest coefficient. For integer hyperplanes with maximum value M normalizing by M gives possible coefficient values

$$\frac{n}{M}$$

where n is an integer between −M and M. Thus increasing M grows the number of feasible hyperplanes. In an embodiment, when solving this problem the system and/or method may only consider data points in Cᵢ and Cⱼ, which in settings with a large number of clusters can be substantially less than the full data set. This allows the formulation to scale to larger datasets while limiting the computational burden of solving each individual integer programming (IP).

Silhouette Clustering with Cardinality Constraints

A system and/or method in an embodiment can also consider the problem of finding cluster assignments. High quality clusters are generally defined by having low intra-cluster distance (i.e., the distance between points in the same cluster), and high inter-cluster distance (i.e., distance between points in different clusters). There are a number of cluster quality metrics that incorporate this high-level concept, one being silhouette coefficient. The silhouette coefficient uses the average distance between a data point t and all other data in the same cluster as a measure of intra-cluster distance, and the average distance between t and every point in the second closest cluster as a measure of inter-cluster distance.

Definition 1 (Silhouette Coefficient) Consider data point t with cluster label k. Let r(t) be the average distance between data point t and every other point in the same cluster. Let q(t) be the average distance between data point t and every point in the second closest cluster. The silhouette score s(t) for data point t can be defined as:

$$r ( t ) = \frac{1}{\vert {C}_{k} \vert - 1} {Σ}_{j ∈ {C}_{k}} {d}_{tj} \\ q ( t ) = {min}_{l = 1 , … , K : l \neq k} \frac{1}{\vert {C}_{l} \vert} {Σ}_{j ∈ {C}_{l}} {d}_{tj} \\ s ( t ) = \frac{q ( t ) - r ( t )}{max ( q ( t ) , r ( t ) )}$$

The silhouette score for a set of cluster assignments can be the average of the silhouette scores for all the data points. The possible values can range from −1 (worst) to +1 (best).

In an embodiment, the system and/or method can formulate the silhouette clustering problem as a MINLP. Let zₜₖ be the binary variable indicating whether data point t is assigned to cluster k, and the variables uₖ be the binary variable indicating whether cluster k is used. To track the silhouette coefficient, let sₜ be the silhouette score for data point t, qₜ represent the intercluster distance measure q(t), and rₜ represent the intracluster distance measure r(t). Let cₜₖ track the distance from data point t to cluster k, and γₜₖ be the binary variable indicating the second closest cluster for data point t. Using this notation, the formulation for finding the cluster assignments can be:

$$\begin{matrix}{min}_{z , {c}_{k} , {u}_{k}} - \frac{1}{n} {Σ}_{t ∈ D} {s}_{t} & ( 13 ) \\ subject to {\sum }_{k = 1}^{K} {z}_{tk} = 1 , ∀ t ∈ 𝒟 & ( 14 ) \\ {N}_{min} {u}_{k} \leq {Σ}_{t ∈ 𝒟} {z}_{tk} \leq {N}_{max} {u}_{k} , ∀ k = 1 , … , K & ( 15 ) \\ {s}_{t} = \frac{{q}_{t} - {r}_{t}}{{m}_{t}} , ∀ t ∈ D & ( 16 ) \\ {c}_{tk} = \frac{1}{{N}_{k}} {Σ}_{j ∈ D} {d}_{ij} {z}_{jk} , ∀ t , k & ( 17 ) \\ {N}_{k} = {Σ}_{t ∈ D} {z}_{tk} , ∀ k ∈ [ K ] & ( 18 ) \\ {r}_{t} = {Σ}_{k} {c}_{tk} {z}_{tk} , ∀ t ∈ D & ( 19 ) \\ {q}_{t} \geq {Σ}_{k} {γ}_{tk} {c}_{tk} , ∀ t ∈ D & ( 20 ) \\ {Σ}_{k} {γ}_{tk} = 1 , ∀ t ∈ D & ( 21 ) \\ {γ}_{tk} \leq 1 - {z}_{tk} , ∀ t ∈ D & ( 22 ) \\ {m}_{t} \geq {r}_{t} , {q}_{t} & ( 23 ) \\ {u}_{k} , {z}_{k} ∈ \{ 0 , 1 \} . & ( 24 )\end{matrix}$$

In an embodiment, the objective of the formulation is to maximize the silhouette coefficient. Constraint (14) ensures that the system and/or method assign each data point to at most one cluster. Constraint (15) sets cardinality constraints (i.e., minimum and maximum values: Nₘᵢₙ and Nₘₐₓ) on the size of the clusters. Constraints (16)-(23) track the silhouette coefficient for each data point t. This formulation is a mixed integer non-linear program with non-linearity introduced by the silhouette coefficient.

Joint Optimization Framework

In an embodiment, the joint framework for clustering and polytope construction aims to both maximize cluster quality, defined by the silhouette coefficient, and minimize the representation error. In an embodiment, to control the relative importance given to representation error and cluster quality, the system and/or method also introduce a regularization parameter λ. The system and/or method in an embodiment define the representation error as the sum of the mis-classification costs for all the hyperplanes defining each cluster's polytope. Given a hyperplane between two clusters Cᵢ, Cⱼ, the system and/or method can determine the hypothetical mis-classification error for every data point (including those not in Cᵢ and Cⱼ) if they were assigned to Cᵢ or Cⱼ by computing the distance from the point to the hyperplane. Let (ξ₊^{ij})ₜ and (ξ₋^{ij})ₜ be the error for data point t if it is assigned to cluster i and j respectively. Let K×K be the set of all pairs of clusters. Combining the hyperplane and clustering formulations, the joint framework for constructing polytope clusters can be:

$$\begin{matrix}{min}_{z , {c}_{k} , {u}_{k}} - \frac{1}{n} {Σ}_{t ∈ D} {s}_{t} + & ( 25 ) \\ λ {Σ}_{x} {t}_{∈ 𝒟} {\sum }_{i = 1}^{K - 1} {\sum }_{j = i + 1}^{K} ( {{z}_{tk} ( {ξ}_{+}^{ij} )}_{t} + {{z}_{tj} ( {ξ}_{-}^{ij} )}_{t} ) & ( 26 ) \\ s . t . , ( 14 ) - ( 24 ) & ( 27 ) \\ ( 4 ) - ( 12 ) for i , j ∈ K \times K & ( 28 ) \\ {( {w}^{ij} )}^{T} {x}^{t} + {b}^{ij} \geq - {( {ξ}_{+}^{ij} )}_{t} , ∀ i , j ∈ K \times K , t ∈ D & ( 29 ) \\ {( {w}^{ij} )}^{T} {x}^{t} + {b}^{ij} + ϵ \leq {( {ξ}_{-}^{ij} )}_{t} , ∀ i , j ∈ K \times K , t ∈ D & ( 30 )\end{matrix}$$

The objective now trades off cluster quality, i.e., Eq. (25), and representation error, i.e., Eq. (26). There can be one separating hyperplane problem per pair of clusters.

In an embodiment, there is no requirement that the feature space for clustering and hyperplane separation be the same. For instance real valued features can be used to compute the cluster quality, but the separation can be done in a binarized feature space, for example, to ensure more interpretable explanations.

In an embodiment, to facilitate optimizing the joint formulation for polytope clustering (an MILNP, which can be difficult to optimize globally), the system and/or method can use a two-state procedure to find a high quality approximation of the solution. In an embodiment, in the first stage, the system and/or method use alternating minimization to find an initial set of clusters and separating hyperplanes. The system and/or method may then coordinate descent to improve the clustering performance of assignments and explanations.

Initialization Via Alternating Minimization

In an embodiment, the system and/or method decompose the joint framework of Eq. (25)-(30) into two components: cluster assignments (e.g., shown at Eq. (25)), and constructing hyperplanes to separate clusters (e.g., shown at Eq. (26)). In an initialization procedure, the system and/or method alternate between clustering the points into K clusters C₁, C₂, . . . C_{K} and then constructing interpretable separating hyperplanes between each pair of clusters. The silhouette clustering problem as described above may remain a difficult problem to solve due to the non-linearity presented by the silhouette metric. In an embodiment, for computational tractability, the system and/or method can use the k-means clustering objective as a proxy for silhouette coefficient during the initialization phase. This can lead to the following much simpler formulation for determining cluster assignments:

$${min}_{z , {c}_{k} , {u}_{k}} {\sum }_{k = 1}^{K} {Σ}_{{x}^{t} ∈ 𝒟} {z}_{tk} {‖ {x}^{t} - {c}_{k} ‖}^{2} + λ {Σ}_{{x}^{t} ∈ 𝒟} {\sum }_{i = 1}^{K - 1} {\sum }_{j = i + 1}^{K} ( {{z}_{tk} ( {ξ}_{+}^{ij} )}_{t} + {{z}_{tj} ( {ξ}_{-}^{ij} )}_{t} ) \qquad ( 31 )$$

$$s . t . , ( 14 ) - ( 15 ) \qquad ( 32 )$$

This problem can now be considered to be similar to a traditional k-means clustering problem, with an additional objective term to capture representation error. In an embodiment, the system and/or method can denote this new clustering formulation the representation aware k-means clustering problem. To solve this formulation for a fixed set of representation errors ξ the system and/or method can alternate between fixing the cluster centers cₖ and generating assignments by solving the IP, and then fix the assignments and update the cluster centers and repeat the process until convergence. For instance, to begin the initialization procedure the system and/or method solve the cluster assignment with no representation errors (i.e., ξₜ=0 ∀t), and then generate polytopes by solving the separating hyperplane problem described above (interpretable separating hyperplanes) for every pair of clusters. The representation errors generated by the separating hyperplane problems are then used in the representation aware k-means problem and the process is repeated until convergence.

Algorithm 1 below shows an initialization procedure in an embodiment.

Algorithm 1: Cluster Initialization via Alternating Minimization

| Inputs: | Data D, initial number of clusters K, λ ≥ 0, M ∈ [symbol] > 1, |
|---|---|
| | β ∈ [symbol] > 1, ϵ > 0 |
| Output: | Cluster assignments z ∈ {0,1}^{n×K} , separating hyperplanes w, |
| | b |
| 1: | Set (ξ₊^{ij})ₜ = (ξ₋^{ij})ₜ = 0 ∀i, j, t |
| 2: | Initialize zₜₖ, cₖ using conventional k-means algorithm on D |
| 3: | for l = 1,2, ... do |
| 4: | /* Compute Cluster Assignments */ |
| 5: | for m = 1,2, ... do |
| 6: | Fix cₖ. Solve (31)-(32) for updated zₜₖ |
| 7: | $Set {c}_{k} = \frac{1}{{N}_{k}} {\sum }_{t ∈ D} {z}_{tk} {x}^{t} , {N}_{k} = {\sum }_{t ∈ D} {z}_{tk} .$ |
| 8: | end for |
| 9: | Set Cᵢ = {x^{t} ∈ D: zₜᵢ = 1} ∀i = 1, ... , K |
| 10: | /* Compute Separating Hyperplanes */ |
| 11: | for i = 1, ... K − 1 do |
| 12: | for j = i + 1,, ... , K do |
| 13: | Solve (1)-(12) with M, β, Cᵢ, Cⱼ for w^{ij}, b^{ij} |
| 14: | Set (ξ₊^{ij})ₜ = max(−w^{ij}x^{t} + b, 0) ∀t ∈ D |
| 15: | Set (ξ₋^{ij})ₜ = max(w^{ij}x^{t} + b + ϵ, 0) ∀t ∈ D |
| 16: | end for |
| 17: | end for |
| 18: | end for |
| 19: | return z, w, b |

In an embodiment, the system and/or method can use k-means as a proxy for silhouette coefficient. K-means can have relative ease of optimization and generally performs well as a proxy for silhouette coefficient. In the absence of interpretability constraints on the separating hyperplanes, all local solutions of the k-means clustering problem also have the appealing property that they can be perfectly explained by a polytope.

Theorem 1 (k-means Polytope Interpretability). Local solutions to the k-means clustering problem with Euclidean distance can be perfectly separated from the other clusters by a polytope. This result may not hold with the addition of interpretability constraints. However, the following theorem shows that an initialization procedure disclosed herein can still be guaranteed to converge to a solution in a finite number of iterations.

Theorem 2 (Alternating Minimization Improvement). Algorithm 1 generates objective values for the representation aware k-means clustering problem that are monotonically decreasing for l≥2, and terminates in a finite number of iterations.

Coordinate Descent

Once an initial clustering and polytope explanation are in place, the system and/or method can use a local search procedure to optimize the original clustering objective. In the local search, the system and/or method can consider each polytope and try to adjust it to boost clustering performance. In an embodiment, the system and/or method may consider the following local search operations:
Boundary Shift: For a given hyperplane the system and/or method can alter the slope and the intercept of the hyperplane and change cluster assignments based on the new boundary. This can be considered as shifting one boundary of the defining polytope for a cluster. Here M and α restrict the search space of potential hyperplanes to consider, making an exhaustive consideration of potential hyperplanes feasible for small M and α.
Cluster Splitting: For a given cluster the system and/or method can attempt to add a new hyperplane to split the cluster into two smaller clusters. Here the system and/or method can consider any feasible separating hyperplane (i.e., in accordance with M and α).
Cluster Merging: For two adjacent clusters (i.e., two clusters separated only by one hyperplane), the system and/or method can attempt to remove that hyperplane and merge the clusters.

In an embodiment, the system and/or method can consider each local search operation and retain the cluster assignment with the best objective value. One of the properties of this coordinate descent approach is that it can increase or decrease the number of clusters present in the assignment through merging or splitting clusters. This allows the approach disclosed herein to be less sensitive to the initial number of clusters specified during the initialization procedure. To provide a fair comparison to algorithms that have a fixed number of clusters and to support applications where there is a constraint on the number of clusters desired, the coordinate descent procedure in an embodiment also puts an upper bound on the total number of possible clusters that can be generated. Algorithm 2 outlines a clustering algorithm including coordinate descent in an embodiment.

Algorithm 2: Multi-Polytope Clustering (MPC) Algorithm

| Input: | Data [symbol] , initial number of clusters K, maximum cluster number Kₘₐₓ, λ ≥ 0, M ∈ |
|---|---|
| | [symbol] , M ≥ 1, β ∈ [symbol] , β ≥ 1 |
| Output: | Cluster assignments z ∈ {0,1}^{nxK}, separating hyperplanes w, b |
| 1: | Initialize z, w, b using Algorithm 1 |
| 2: | Initialize processing queue Q with all hyperplane indices ((i, j) ∀i = 1, ..., K − |
| | 1, j = i + 1, ..., K) and cluster indices (i = 1, ..., K) |
| 3: | Compute current loss [symbol] using (31) with cluster assignment z |
| 4: | while Q is not empty do |
| 5: | for q ∈ Q do |
| 6: | if q corresponds to a hyperplane (i, j) then |
| 7: | Find best new hyperplane between i, j |
| 8: | else if q corresponds to cluster Cᵢ then |
| 9: | Find best split for cluster Cᵢ |
| 10: | end if |
| 11: | Compute updated loss [symbol] ′ using (31) |
| 12: | if [symbol] ′ < [symbol] then |
| 13: | Update z, [symbol] = [symbol] ′, w, b |
| 14: | Reset Q with all hyperplanes and clusters |
| 15: | end if |
| 16 | end for |
| 17: | end while |
| 18: | return z, w, b |

In an embodiment, the optimization procedure can be flexible in that it can choose a clustering metric to use during coordinate descent. For example, silhouette coefficient is chosen as one example. Thus, the framework disclosed herein can be easily extended to other clustering metrics such as Dunn Index.

Briefly, the following shows Dunn Index computation:

$${Δ}_{k} = {max}_{i , j ∈ {C}_{k}} d ( i , j ) \\ δ ( {C}_{i} , {C}_{j} ) = {min}_{i ∈ {C}_{i} , j ∈ {C}_{j}} d ( i , j ) \\ DI = \frac{{min}_{1 \leq i < \leq m} δ ( {C}_{i} {C}_{j} )}{{max}_{1 \leq k \leq m} {Δ}_{k}}$$

Experimental runs and results performed both on synthetic dataset and real data set (e.g., a relatively large dataset having relatively large dimensions (features)) show that the multi-polytope clustering (MPC) disclosed herein can outperform existing interpretable clustering machine learning methodologies. Different hyperparameters can be used to represent different levels of interpretability. For example, setting hyperparameters M=β=1 can represent cluster explanations with only axis-parallel hyperplanes, providing a fair comparison to univariate decision tree based methods. Setting M=3, β=2 can allow for more general hyperplanes with up to two non-zero integer coefficients and coefficients within [−3,3]. In an embodiment, feature values in datasets can be normalized, for example, to be between 0 and 1, for numeric features. For categorical feature values, a one hot encoding can be applied. For example, each feature in a dataset can be normalized to be between 0 and 1 using a standard max-min rescaling function. Categorical features can be converted using one hot encoding. In an embodiment, data in the dataset with missing values may be removed. In an embodiment, k can be tuned to take values, for example between 2 and 10 (by way of example only). Available solvers can be used with default parameters to solve the linear and integer programs in the framework. Further available k-means implementation included in code packages can be used to initialize clustering. The random seed can be set or configured to a value, for example, 42.

Interpretability

The output of Algorithm 2 is a set of cluster assignments and hyperplanes between clusters. To construct an explanation for a given cluster the system and/or method can include all hyperplanes related to the cluster to construct a polytope. In an embodiment, the system and/or method may remove redundant hyperplanes (i.e., ones weaker than other constraints already included in the polytope). The flexibility of the MPC framework allows the resulting polytope explanation to resemble a number of different model classes. If the system and/or method restrict the polytopes to only include axis-parallel hyperplanes (i.e., M=β=1), then each cluster example can be considered a rule. A sample cluster explanation for an example Zoo related dataset can be: (HAS HAIR) AND (HAS MILK) AND (LEGS >0).

Each hyperplane corresponds to a single clause in the resulting rule. For example, this rule may be equivalent to one leaf node in a decision tree, however, the unordered conditions in a rule can be easier to interpret than a decision tree.

If β is increased, each explanation resembles a rule set where each hyperplane constitutes a rule. for example, in a zoo related datasets, which contains primarily boolean features meaning that each hyperplane corresponds to a scorecard where each condition has an associated weight which is compared against a threshold. One cluster explanation for such zoo related dataset with β=2, M=3 can be: [(DOMESTIC)+(HAS EGGS)>1] AND (HAS TEETH).

In this example the first rule in the rule set is a scorecard (both conditions need to be met). The rule sets can provide a relative clear explanation that can be understood. For datasets with non-binarized features, the explanations remain rule sets but each rule is a more general linear condition. For example, one cluster explanation for beverage related dataset with β=2, M=3 can be:

[3*(CITRICACIDITY)+9*(DENSITY)<1.42]

AND

[1*(pHLEVEL)+2*(CHLORIDES)≥0.58]

The explanation remains audit-able which can be suitable for a number of applications. To improve the interpretability of explanations for datasets with real valued features, users can use binarized features for polytope construction. Another benefit of the MPC framework is that it provides pairwise comparisons between clusters. For instance, the hyperplane separating each pair of clusters acts as a pairwise comparison. A pairwise comparison between two clusters in the zoo related dataset (for M=β=1) can be: IF (HAS HAIR): Cluster 3 ELSE Cluster 4.

In an embodiment, the algorithm disclosed herein for interpretable clustering describes clusters using polytopes. The system and/or method may formulate the problem of jointly clustering and explaining clusters as a MINLP that optimizes both silhouette coefficient and representation error. An IP formulation for finding separating hyperplanes can be used to enforce interpretability considerations on the resulting polytopes. To approximate a solution to the MINLP the system and/or method can leverage a two-phase optimization approach that first generates an initial set of clusters and polytopes using alternating minimization, then improves clustering performance using coordinate descent. Compared to state of the art uninterpretable and interpretable clustering algorithms the approach disclosed herein can find high quality clusters while preserving interpretability.

Theorem 3 (K-Means Polytope Interpretability). Local solutions to the k-means clustering problem with Euclidean distance can be perfectly separated from the other clusters by a polytope.

Proof. Let C={C₁, C₂, . . . , C_{K}} be a local solution to the k-means clustering problem. It can be started by proving that any two arbitrary clusters Cᵢ, Cⱼ can be perfect separated by a linear hyperplane. Let cⁱ, c^{j} be the cluster center of Cᵢ, Cⱼ respectively. Local solutions must satisfy x∈Cᵢ∥x−cⁱ∥<∥x−c^{j}∥, otherwise simply changing the cluster of x from Cᵢ to Cⱼ would lead to a lower objective. Without a loss of generality it may be assumed that all points that are equidistant from both centers are assigned to Cᵢ. The assignment with deterministic tie-breaking can achieve the same k-means objective and thus is also a local minimum. Consider the following hyperplane w^{T}x+b=0 defined by:

$$w = {c}^{j} - {c}^{i} b = - {( {c}^{j} - {c}^{i} )}^{T} ( \frac{{c}^{i} + {c}^{j}}{2} ) .$$

It can be proposed that this line perfectly separates the two clusters. Without a loss of generality assume that all points in j lie above the plane (i.e., w^{T}x+b≥0 ∀x∈Cⱼ), and all points in i lie below it (i.e., w^{T}x+b≤0 ∀x∈Cᵢ). Suppose this were not true, then there would exists a point x∈Cᵢ such that w^{T}x+b>0. Since x∈Cᵢ, it can be that ∥x−cⁱ∥<∥x−c^{j}∥, otherwise there would be a contradiction to the assignment being an output from the k-means algorithm. Using some simple algebra the following can be obtained:

$${w}^{T} x + b = {( {c}_{j} - {c}_{i} )}^{Y} x - {( {c}_{j} - {c}_{i} )}^{T} \frac{( {c}_{i} + {c}_{j} )}{2} = {x}^{T} {c}_{j} - {x}^{T} {c}_{i} - \frac{1}{2} {( {c}_{j} )}^{T} {c}_{j} + \frac{1}{2} {( {c}_{i} )}^{T} {c}_{i} = \frac{1}{2} ( {‖ x - {c}_{i} ‖}^{2} - {‖ x - {c}_{j} ‖}^{2} )$$

This implies

w^{T}x+b>0⇒∥x−cᵢ∥≥∥x−cⱼ∥,

which contradicts ∥x−cᵢ∥<∥x−cⱼ∥. An identical argument also works for x∈Cⱼ such that w^{T}x+b>0, and thus the given hyperplane must divide the two clusters.

Now consider an arbitrary cluster Cᵢ, and create a hyperplane between Cᵢ and every other cluster. The set of hyperplanes now defines a polytope that contains Cᵢ and separates it from the other clusters.

Theorem 4 (Alternating Minimization Improvement). Algorithm 2 generates objective values for the representation aware k-means clustering problem that are monotonically decreasing for l≥2, and terminates in a finite number of iterations.

Proof. It can be started by showing that for l≥2, each loop of Algorithm 1 produces a monotonically decreasing objective value. After iteration l=1 there can be a feasible cluster assignment z and a set of separating hyperplanes w, b. It can now be shown that after a single pass through the loop of Algorithm 1, the objective for Problem (31)-(32) either decreases or remains the same triggering the end of the algorithm.

First consider the loop to adjust cluster assignments by solving Problem (31)-(32) (lines 4-8). Since there is a feasible assignment, the existing solution is feasible to the updated version of Problem (31)-(33) with the given from the current separating hyperplanes. The clustering assignment portion of Algorithm 1 can be started with the current assignment, thus solving (32)-(33) with the current cₖ can result in an equal or lower objective value. Based on the same logic as to the original k-means, updating cₖ is also guaranteed to maintain or decrease the objective value. By an identical argument every iteration of the clustering loop would similarly only maintain or decrease the current objective value, ensuring that the cluster assignment results in an equal or lower objective value to the previous assignment.

Next consider solving the separating hyperplane problem for clusters i and j. Since each sub-problem only includes data points involved in cluster i and j, the objective for problem (1)-(12) is equal to the contribution of objective term (26) for clusters i and j for the current assignment z. The resulting solution returned by solving the IP (1)-(12) can therefore result in a hyperplane with an objective term less than or equal to the current solution. Since this holds for the hyperplane between arbitrary clusters i and j, it holds for every pair of clusters and thus the output of separating hyperplane loop results in an equal or lower objective.

If the objective value remains constant, the algorithm terminates, thus ensuring that Algorithm 1 leads to a monotonically decreasing series of objective values for problem (32)-(33). The finite termination condition follows from there being a finite number of possible cluster configurations and integral separating hyperplanes.

As described above, in one or more embodiments, a system and/or method may combine clustering and polytope construction into a single Mixed Integer Nonlinear Program (MINLP) optimization formulation, to obtain a new clustering algorithm. In an embodiment, a representation aware K-means clustering formulation clusters with awareness of representation error using Silhouette, Dunn index metrics, or another cluster performance metrics. A formulation can be provided for finding interpretable separating hyperplanes with sparse integer coefficients for interpretability. A system and/or method may enclose clusters within sparse separating hyperplanes with small integer coefficients and large margins. A two-stage optimization procedure can be provided that initializes clusters via alternating minimization and then optimizes cluster performance metrics such as Silhouette or Dunn index metrics via coordinate descent.

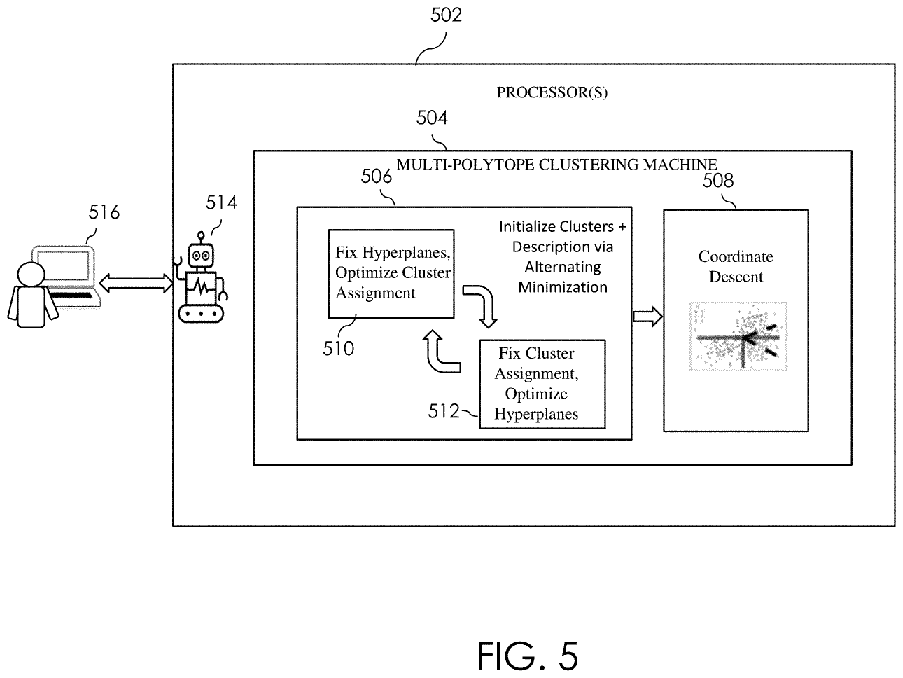

FIG. 5 is another diagram illustrating a framework for interpretable unsupervised machine learning or clustering with muti-polytope machines in an embodiment. One or more computer processors, e.g., computer processors and/or hardware processors 502 may implement or run the framework. As described herein, the framework can include a muti-polytope clustering (MPC) 504 which can jointly cluster and provide cluster representation (interpretation), for example, jointly solve optimizing of cluster assignments and representation. Solving an MPC problem can include generating an initial clustering and hyperplane separation 506, then performing local search to boost performance 508. In initial clustering and hyperplane separation 506, clusters and description can be generated using alternating minimization technique. For example, cluster assignments can be optimized with fixed hyperplanes 510, and hyperplanes can be optimized with fixed cluster assignment 512. The procedure can repeat until convergence, e.g., an error term is below a threshold. The output of the initial clustering and hyperplane separation 506 can further be improved by performing coordinate descent 508. In an embodiment, the output clusters or cluster assignments and associated interpretations (based on the hyperplanes that construct polytopes that contain the clusters, respectively), can further be used to trigger an automated action. For example, a chatbot 514 which can be a component of a user interface can automatically launch to provide the output cluster assignments and associated interpretations, engaging a user in an interactive conversation with the user via user computer 516. As another example, a chatbot 514 can interactively engage in conversation with the user to refine parameters M and β in providing flexibility in interpretability. In another aspect, such a chatbot 514 can readily and interactively provide explanations for its actions or actions performed automatically on or by a device based on determining cluster assignments. An example of an automated action can include recommending certain products based on cluster assignments. For example, based on cluster assignments of streaming service viewer preferences, a video can be automatically selected for a viewer, which can trigger an automatic play of a preview on a streaming device. An explanation of the selection can be readily provided based on the interpretability determined according to one or more embodiments of a system and/or method disclosed herein. Other automatic or autonomous actuations can be triggered based on the clustering assignment and provided interpretation.

Another example use case can be in customer segmentation. Consider an online grocery retailer (or other commercial entity) that wants to design product promotion based around common types of customers in their system. The output of an interpretable clustering can be a description of the different customer segments in their historical data. For example, for each cluster, the online grocery retailer may use the defining characteristics (e.g., cluster 1 is defined by having purchased more vegetables than the other customers) to generate a special advert for that cluster (e.g., automatically launch or send via a computer network a promotion on seasonal produce). Still another example use case can be in education placement. Consider a school that is trying to create specialized class sessions for students in a program. The students each have associated grades and performance in different subjects. The output of an interpretable clustering algorithm can be groups of students with distinguishing characteristics. These defining characteristics can then be used to implement specialized education programs (e.g., bonus science education that tries to make connections to critical thinking skills from a language class).

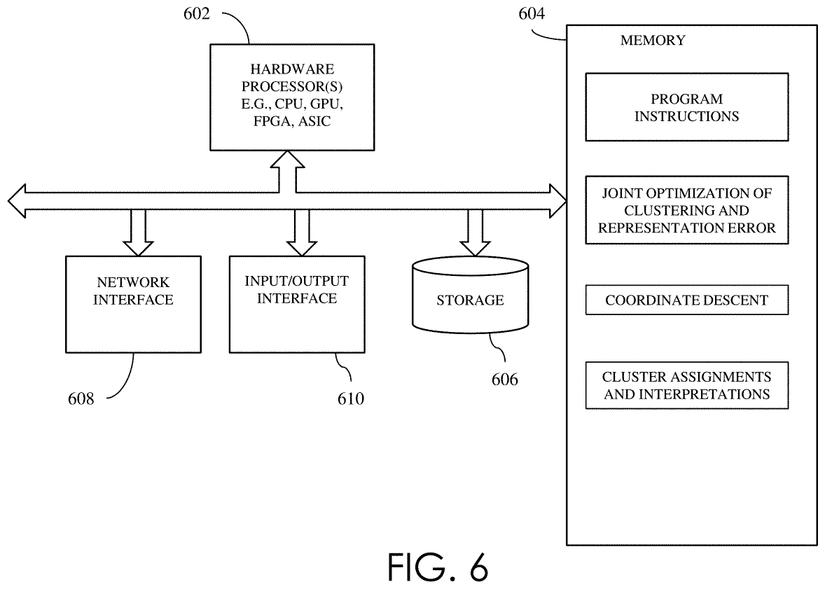

FIG. 6 is a diagram showing components of a system in one embodiment that can perform interpretable clustering with multiple polytope machines. One or more hardware processors 602 such as a central processing unit (CPU), a graphic process unit (GPU), and/or a Field Programmable Gate Array (FPGA), an application specific integrated circuit (ASIC), and/or another processor, may be coupled with a memory device 604, and generate interpretable clusters, e.g., cluster assignments and interpretations. A memory device 604 may include random access memory (RAM), read-only memory (ROM) or another memory device, and may store data and/or processor instructions for implementing various functionalities associated with the methods and/or systems described herein. One or more processors 602 may execute computer instructions stored in memory 604 or received from another computer device or medium. A memory device 604 may, for example, store instructions and/or data for functioning of one or more hardware processors 602, and may include an operating system and other program of instructions and/or data. One or more hardware processors 602 may receive one or more datasets for clustering. One or more hardware processors 602 may cluster the dataset into clusters and also generate hyperplanes in a multi-dimensional feature space of the dataset, the hyperplanes separating pairs of the clusters, where a hyperplane separates a pair of clusters. The clustering and generating can be repeated until convergence, where the clustering in a subsequent iteration uses the generated hyperplanes from a previous iteration to optimize performance of the clustering. In an embodiment, one or more hardware processors 602 may solve an optimization problem that jointly optimizes the quality of clusters while generating the clusters and the quality of explanations while generating the explanations for the clusters. One or more hardware processors 602 may adjust the hyperplanes to further improve the performance of the clustering. One or more hardware processors 602 may provide the clusters and interpretation of the clusters, where a cluster's interpretation is provided based on hyperplanes that construct a polytope containing the cluster. One or more input dataset may be stored in a storage device 606 or received via a network interface 608 from a remote device, and may be temporarily loaded into a memory device 604 for performing interpretable clustering. The learned cluster assignments and interpretations may be stored on a memory device 604, for example, for use by one or more hardware processors 602. One or more hardware processors 602 may be coupled with interface devices such as a network interface 608 for communicating with remote systems, for example, via a network, and an input/output interface 610 for communicating with input and/or output devices such as a keyboard, mouse, display, and/or others.

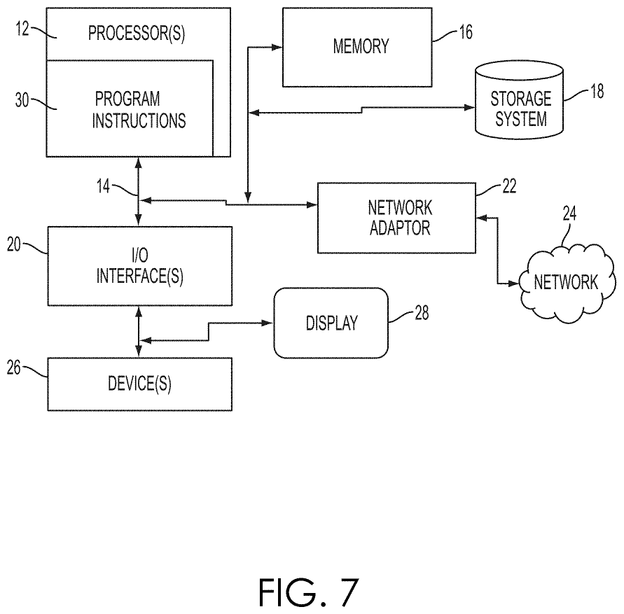

FIG. 7 illustrates a schematic of an example computer or processing system that may implement a system in one embodiment. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being run by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

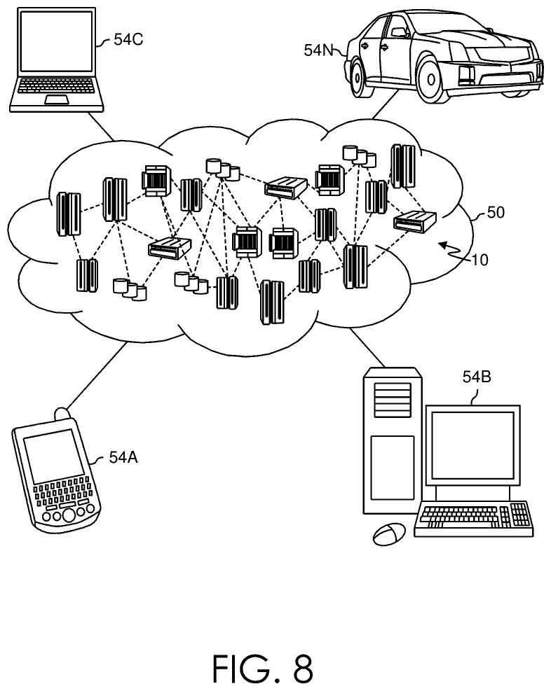

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

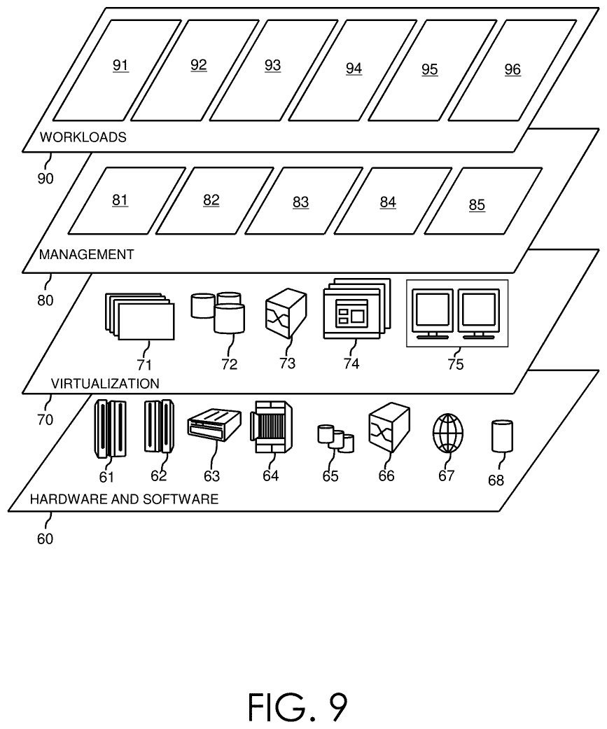

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and unsupervised clustering with multi-polytope machines processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, run concurrently, substantially concurrently, in a partially or wholly temporally overlapping manner, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for training a machine to perform unsupervised interpretable machine learning, comprising:
at least one processor; and
a memory device coupled with the at least one processor;
the at least one processor configured to at least:
receive a dataset having multiple features;
train to jointly cluster and interpret resulting clusters of the dataset by at least:
clustering the dataset into clusters;
generating hyperplanes in a multi-dimensional feature space of the dataset, the hyperplanes separating pairs of the clusters, wherein a hyperplane separates a pair of clusters;
repeating the clustering and generating until convergence, wherein the clustering in a subsequent iteration uses the generated hyperplanes from a previous iteration to optimize performance of the clustering;
adjusting the hyperplanes to further improve the performance of the clustering;
providing the clusters and interpretation of the clusters, wherein a cluster's interpretation is provided based on hyperplanes that construct a polytope containing the cluster.

2. The system of claim 1, wherein the clustering and the generating of the hyperplanes are performed as a single mixed integer non-linear programming that solves alternating minimization between the clustering and the hyperplane generating.

3. The system of claim 1, wherein the clustering is implemented using a representation aware k-means clustering that clusters with awareness of representation error using a clustering metric.

4. The system of claim 1, wherein the hyperplanes are generated based on configurable parameters that control sparsity of the hyperplanes for interpretability.

5. The system of claim 1, wherein the adjusting of the hyperplanes is performed based on a selected clustering metric.

6. The system of claim 5, wherein the selected clustering metric includes Silhouette index.

7. The system of claim 5, wherein the selected clustering metric includes Dunn index.

8. A computer-implemented method of training a machine to perform unsupervised interpretable machine learning, comprising:
receiving a dataset having multiple features;
clustering the dataset into clusters;
generating hyperplanes in a multi-dimensional feature space of the dataset, the hyperplanes separating pairs of the clusters, wherein a hyperplane separates a pair of clusters;
repeating the clustering and generating until convergence, wherein the clustering in a subsequent iteration uses the generated hyperplanes from a previous iteration to optimize performance of the clustering;
adjusting the hyperplanes to further improve the performance of the clustering;
providing the clusters and interpretation of the clusters, wherein a cluster's interpretation is provided based on hyperplanes that construct a polytope containing the cluster,
wherein the machine is trained to jointly cluster and interpret resulting clusters of the dataset.

9. The computer-implemented method of claim 8, wherein the clustering and the generating of the hyperplanes are performed as a single mixed integer non-linear programming that solves alternating minimization between the clustering and the hyperplane generating.

10. The computer-implemented method of claim 8, wherein the clustering is implemented using a representation aware k-means clustering that clusters with awareness of representation error using a clustering metric.

11. The computer-implemented method of claim 8, wherein the hyperplanes are generated based on configurable parameters that control sparsity of the hyperplanes for interpretability.

12. The computer-implemented method of claim 8, wherein the adjusting of the hyperplanes is performed based on a selected clustering metric.

13. The computer-implemented method of claim 12, wherein the selected clustering metric includes Silhouette index.

14. The computer-implemented method of claim 12, wherein the selected clustering metric includes Dunn index.

15. A computer program product comprising a computer readable storage medium having program instructions embodied therewith, the program instructions readable by a device to cause the device to:
receive a dataset having multiple features;
train to jointly cluster and interpret resulting clusters of the dataset by at least:
cluster the dataset into clusters;
generate hyperplanes in a multi-dimensional feature space of the dataset, the hyperplanes separating pairs of the clusters, wherein a hyperplane separates a pair of clusters;
repeat clustering and generating until convergence, wherein the clustering in a subsequent iteration uses the generated hyperplanes from a previous iteration to optimize performance of the clustering;
adjust the hyperplanes to further improve the performance of the clustering;
provide the clusters and interpretation of the clusters, wherein a cluster's interpretation is provided based on hyperplanes that construct a polytope containing the cluster.

16. The computer program product of claim 15, wherein the clustering and the generating of the hyperplanes are performed as a single mixed integer non-linear programming that solves alternating minimization between the clustering and the hyperplane generating.

17. The computer program product of claim 15, wherein the clustering is implemented using a representation aware k-means clustering that clusters with awareness of representation error using a clustering metric.

18. The computer program product of claim 15, wherein the hyperplanes are generated based on configurable parameters that control sparsity of the hyperplanes for interpretability.

19. The computer program product of claim 15, wherein the adjusting of the hyperplanes is performed based on a selected clustering metric.

20. The computer program product of claim 19, wherein the selected clustering metric includes at least one selected from the group of Silhouette index and Dunn index.
